(19) United States
(12) Patent Application Publication
(10) Pub. No.: US 2020/0098290 A1
(43) Pub. Date: Mar. 26, 2020

(54) Rolled Label Web Releasably Attached To A Core

(71) Applicant: Kenco Label & Tag Co., LLC, Milwaukee, WI (US)

(72) Inventor: Aharon A. Karan, Milwaukee, WI (US)

(21) Appl. No.: 16/579,370

(22) Filed: Sep. 23, 2019

Related U.S. Application Data
(60) Provisional application No. 62/735,386, filed on Sep. 24, 2018.

(51) Int. Cl. G09F 3/10; G09F 3/02; B31D 1/02

(52) U.S. Cl. CPC G09F 3/10; G09F 2003/0229; B31D 1/02; G09F 3/02

(57) ABSTRACT

A roll of label web and method utilize a length of first label web having a plurality of longitudinally spaced adhesive-backed labels removably attached to a substrate wound around a tubular core in such a manner that a first and last label of the first label web are fully intact and usable. The leading and trailing ends of the first label web are cut between labels. The trailing end of the first label web is releasably attached to the core by double-sided releasable adhesive tabs that allow the trailing end of the first label web to pull free from the core for printing the last label. The leading end of the first label web is temporarily secured to the roll by adhesive tabs that are removable without damaging the first label of the first label web.

### CROSS-REFERENCE TO RELATED APPLICATION

This application claims the benefit of U.S. Patent Application No. 62/735,386; filed on Sep. 24, 2018; entitled “Rolled Label Web Releasably Attached to a Core”; the content of which is incorporated herein by reference in its entirety.

### FIELD OF THE INVENTION

This invention relates generally to forming and using rolls of adhesive-backed labels, and more particularly to forming rolls of adhesive-backed labels for use in label printing machines.

### BACKGROUND OF THE INVENTION

Rolls of adhesive-backed labels are widely used for shipping, inventory control, and other purposes. A large number of labels are typically removably affixed to a backing, or substrate web, to form a so-called label web that is wound around a cardboard core to form a compact roll. The roll is subsequently mounted for continuously feeding the label web through a printer that place addresses, bar codes, or other indicia on the labels while they are attached to the substrate. The printed labels are then removed from the substrate and applied to a shipping or storage container.

Such rolls of adhesive-backed labels are essentially a commodity item and are ideally produced using high-speed, large-volume production methods and machinery, so that they are sold at low cost to consumers.

Prior approaches to producing and using such rolls of labels are less than optimal for several reasons.

A good deal of hand labor is currently involved in making and using the rolls. Typically, the end of the label web that will be the trailing end of the label web during use is secured to the cardboard core by a hand operation using strips of tape that extend over a portion of the last label on the substrate. When a desired number of labels is finished winding onto the core, the label web is typically cut by hand using a scissors, and the trailing end of the web is secured to the outer periphery of the roll by using additional strips of tape applied by hand over a portion of the last label on the roll. This approach typically renders the first and last labels in the roll unusable. Applying the strips of tape in this manner is time consuming and slows the production process undesirably.

In addition, the consumer must trim off the unusable first labels, typically by hand with a scissors before the label web can be fed into the printer. The last label is typically unusable and is attached to the core in such a manner that the trailing end of the label web cannot be fed through the printer, resulting in the printing process being significantly interrupted when the end of the roll of label web is reached.

Also, where automated cutters are used to sever the label web during winding operations, the cut at the end of the label web is often made through one or more of the labels. The end of the roll must then be trimmed by hand by either the manufacturer or by the consumer to remove the partial label, so that the label web can be properly fed into the printer.

It is desirable, therefore, to provide improvements in the configuration of rolls of label web and improvements in the methods of production and use of such rolls of label web that address the above described and other shortcomings with current approaches to making and using rolls of label web.

### BRIEF SUMMARY OF THE INVENTION

The invention provides an improved roll of label web, and methods for making and using such an improved roll of web material, by utilizing a length of first label web having a plurality of longitudinally spaced adhesive-backed labels removably attached to a substrate wound around a tubular core in such a manner that a first and last label of the first label web are fully intact and usable. The leading and trailing ends of the first label web are cut between labels. The trailing end of the first label web is releasably attached to the core by double-sided releasable adhesive tabs that allow the trailing end of the first label web to pull free from the core for printing the last label. The adhesive tabs are provided from a second label web having a plurality of longitudinally spaced arrays of adhesive tabs that are removable for use as a group. The leading end of the first label web is temporarily secured to the roll by adhesive tabs that are removable without damaging the first label of the first label web.

In one form of the invention, a roll of label web may include a length of first label web having a plurality of longitudinally spaced adhesive-backed labels removably attached to a substrate wound around a tubular core in such a manner that a first and last label of the first label web are fully intact and usable. The labels may be disposed in a longitudinally spaced manner from one another along the first label web, and the leading and trailing ends of the first label web may be formed by severing the first label web between successive labels such that the first and last labels of the first label web are complete.

The trailing end of the first label web may be attached to the core prior to winding using one or more double-sided releasable adhesive labels to form a removable adhesive bond between the core and an underside of the substrate in such a manner that the trailing end of the first label web is secured to the core during winding of the roll and can pull free from the core for printing of the last label on the first label web.

In some forms of the invention, the double-sided releasable adhesive labels may be part of an array of such labels configured to be released as a group from a second label web having longitudinally spaced arrays of the double-sided releasable adhesive labels releasably affixed to a substrate web of the second label web. The double-sided releasable adhesive labels may be covered by a peelable protective covering web in a manner that allows each longitudinally spaced array of the second label web to be individually selectively successively uncovered and removed as a group while the peelable protective covering web remains in place over successive label arrays of the second label web.

The leading end of the first label web may be temporarily affixed to the completed roll with one or more removable adhesive tabs that are removable without damaging the first label of the label web.

The invention may also take the form of a method for producing a roll of label web, in accordance with the invention.

Other aspects, objects and advantages of the invention will be apparent from the following detailed description and accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is an isometric view of an exemplary embodiment of a roll of first label web, in accordance with the invention; and

FIGS. 2-12 are a series of isometric operational views sequentially illustrating an exemplary method for forming an exemplary embodiment of a roll of label web wound around a core, in accordance with the invention.

While the invention is described in connection with certain preferred embodiments, there is no intent to limit it to those embodiments. On the contrary, the intent is to cover all alternatives, modifications, and equivalents within the spirit and scope of the invention.

### DETAILED DESCRIPTION OF THE INVENTION

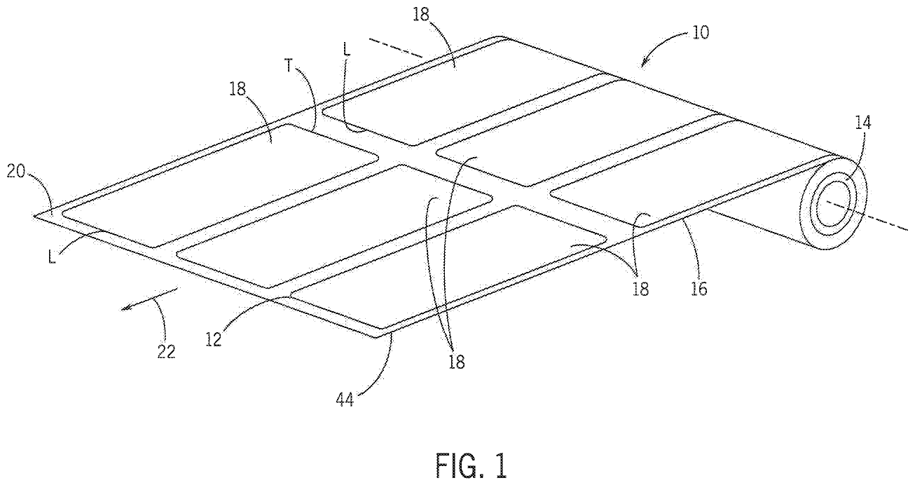

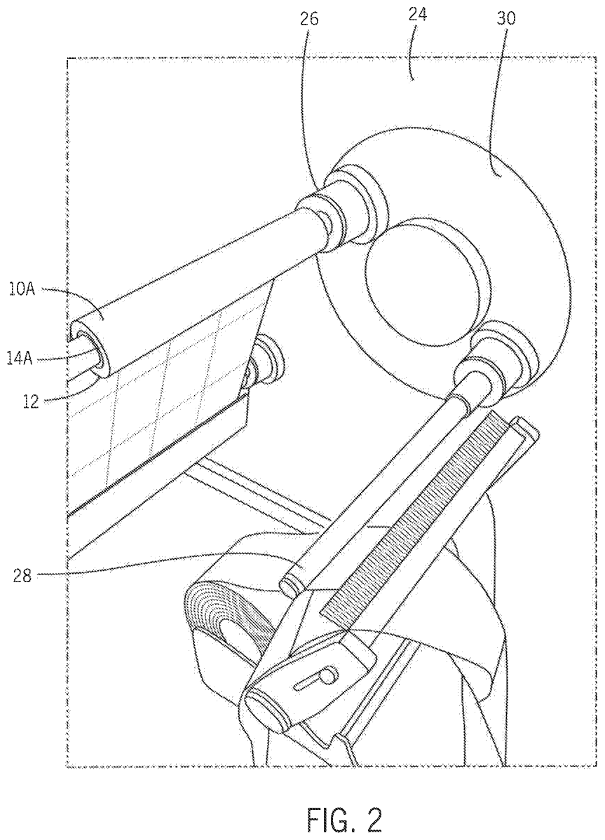

FIG. 1 shows an exemplary embodiment of a roll 10 of a first label web 12 wound about a core 14, in accordance with the invention. FIGS. 2-12 are a series of operational views sequentially illustrating an exemplary method for forming the exemplary embodiment of the roll 10, in accordance with the invention.

As shown in FIG. 1, the first label web 12 includes a substrate 16. A plurality of adhesive-backed labels 18 is releasably attached to a top surface 20 of the substrate 16. The labels 18 each define a respective leading edge L and a training edge T, with leading and trailing referring to the direction 22 that the first label web 12 is fed into a printer.

In the exemplary embodiment of the method illustrated in FIGS. 2-12, the exemplary embodiments of the roll 10 are formed on a dual-spindle winding machine 24 having first and second rotatable spindles 26,28 mounted on rotatable head 30 of the winding machine 24.

In FIG. 2, the first spindle 26 is located in a winding position and being driven to wind the first label web 12 onto a first core 14A to form a first roll 10A. The second spindle 28 is located in a load/unload position and is disengaged from the spindle drive mechanism. The second spindle 28 is empty and ready to receive the core for the next roll to be wound.

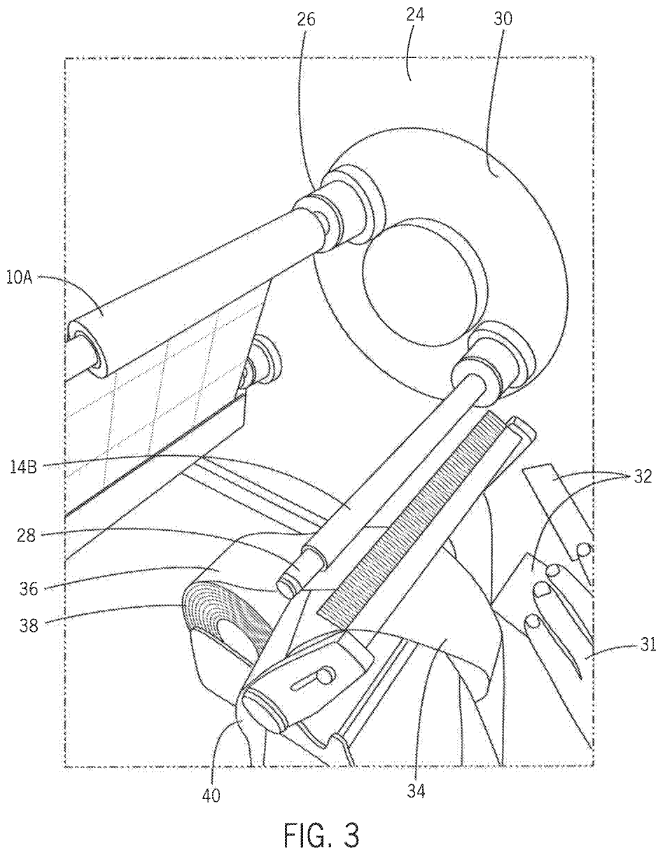

In FIG. 3, winding continues on the first roll 10A, and a second core 14B has been slid into place on the second spindle 28. The first and second spindles 26,28 both have external gripping features (not shown) for internally gripping the cores 14 and causing them to rotate with the spindle 26,28 that they are mounted on.

FIG. 3 also shows an operator 31 removing a group of double-sided adhesive labels 32 from a substrate 34 of a second label web 36 of an adhesive label roll 38. The second label web 36 is configured such that its substrate 34 carries a plurality of longitudinally spaced label arrays each including three double-sided adhesive labels 32 removably attached in a side-by-side pattern transversely across the substrate 34. A peelable protective covering web 40 extends generally coextensive with the substrate 34 of the second label web 36. The arrays of labels 32 and the peelable protective web 40 are configured such that the peelable protective web 40 is peeled off of each successive array of labels 32 as the second label web 36 is drawn toward the operator 31 from the adhesive label roll 38, to thereby expose a single array of the double-sided adhesive labels 32, while remaining removably attached to all successive arrays of double-sided adhesive labels 32. The double-sided adhesive labels 32 of the exposed array remain removably attached to the substrate 34 after the protective web 30 is peeled away, to thereby facilitate removal of all labels 32 in the exposed label array as a group, while the peelable protective covering web 40 remains in place over the successive arrays of double-sided adhesive labels 32.

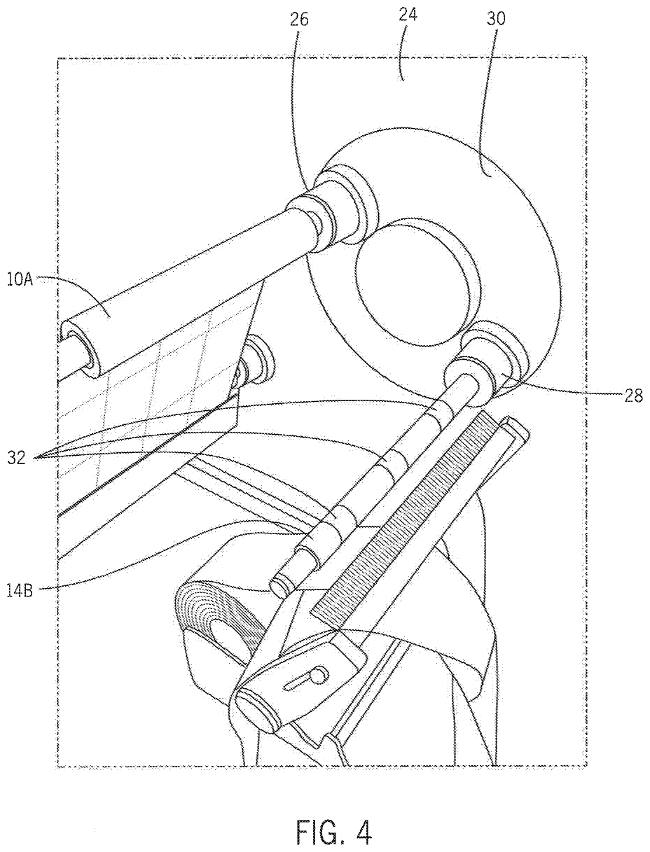

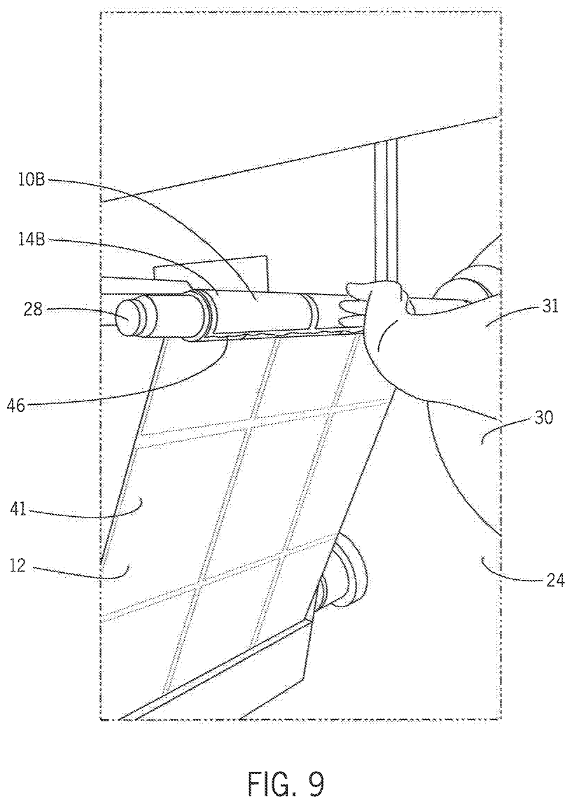

In FIG. 4, the operator 31 has wrapped the three double-sided adhesive labels 32 from the exposed array of double-sided adhesive labels 32 around the core 14B for the next roll 10B (best shown in FIGS. 9-12), at laterally spaced locations along the core 14B.

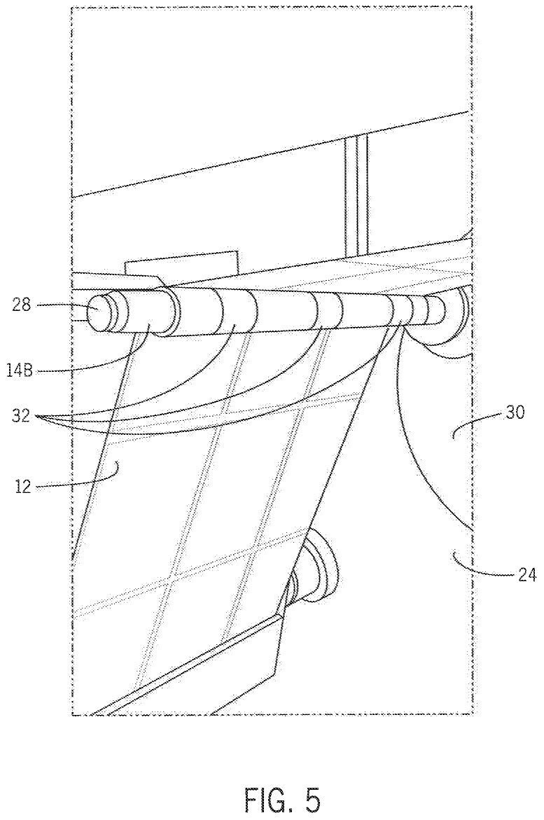

In FIG. 5, winding of the first roll 10A has been substantially completed. The winding rate slows prior to completion and the head 30 of the winding machine 24 rotates to bring the second spindle 28 into the winding position, and move the first spindle 26 (not shown in FIG. 5) around to the load/unload position. The winding machine 24 brings the first spindle 26 to a stop and the second spindle 28 into the winding position at a longitudinal location along the first label web 12 that will allow the first label web 12 to be severed between the leading and trailing edges L,T (see FIG. 1) of longitudinally adjacent labels 18 of the first label web 12, so that the first roll 10A will end with complete labels 18 and the next roll 10B will begin with complete labels 18. In this position, the three double-sided adhesive labels 32 are pressed into contact with a bottom surface 41 (see FIG. 1) of the substrate 16 of the first label web 12 in a manner that bonds the substrate 16 of the first label web 12 to the core 14B of the second roll 10B along an arcuate length of each of the three double-sided adhesive labels 32.

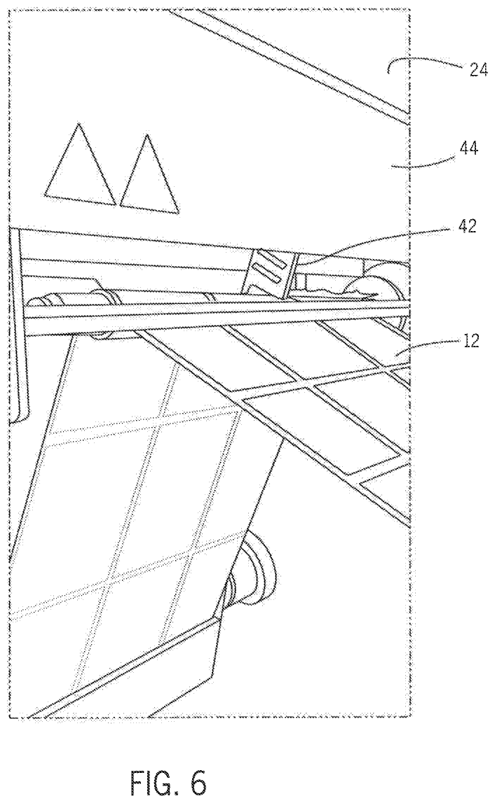

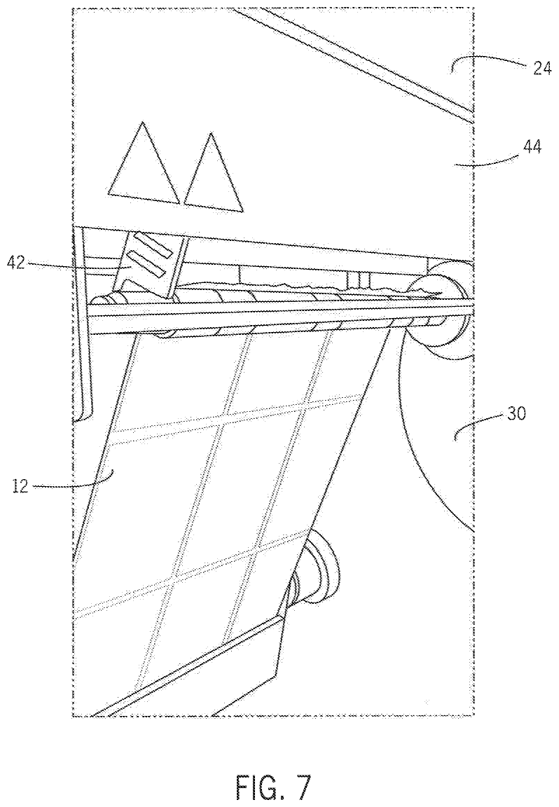

As shown in FIGS. 6 and 7, the first label web 12 is severed between the leading and trailing edges L,T of the labels 18 attached to the first label web 12 by a transversely translating cutter 42 of a movable cutting arrangement 44.

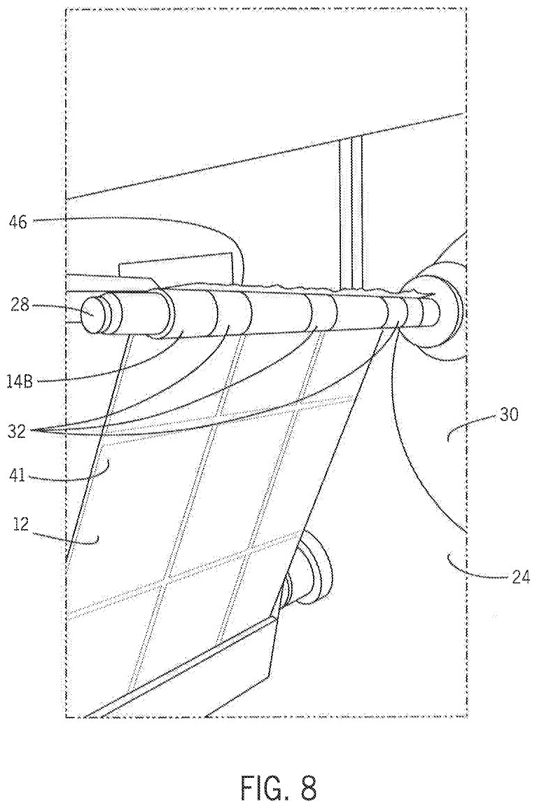

As shown in FIG. 8, the adhesive on the outer periphery of the arcuate length of the double-sided adhesive labels 32 is sufficiently strong to hold a trailing end 46 of the first label web 12 to the core 14B of the next roll 10B during and after severing of the first label web 12 by the cutter 42, while the second spindle 28 is not rotating.

As shown in FIG. 9, prior to beginning winding of the second roll 10B, the operator 31 wraps the trailing end 46 of the severed first label web 12 farther around the core 14B of the second roll 10B to increase the arcuate length of contact between the bottom surface 41 of the substrate 16 of the first label web 12 and the three double-sided adhesive labels 32. This increases the bond strength between the first label web 12 and the three double-sided adhesive labels 32, to thereby facilitate winding.

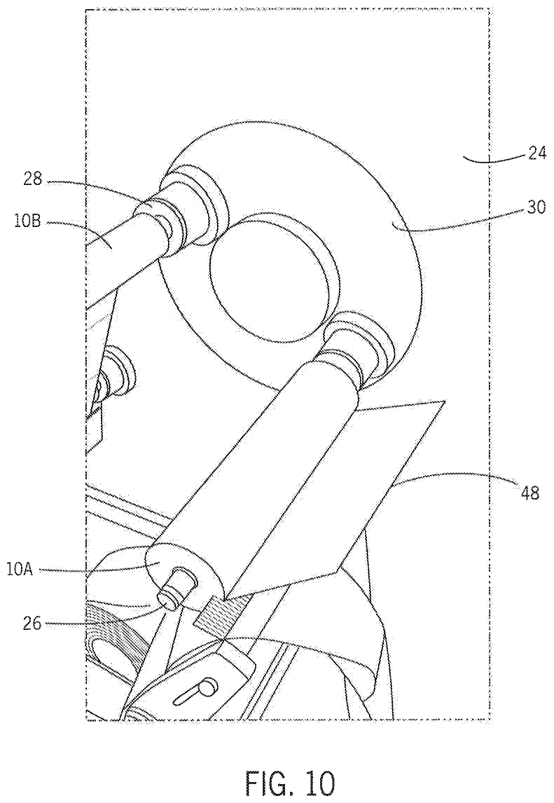

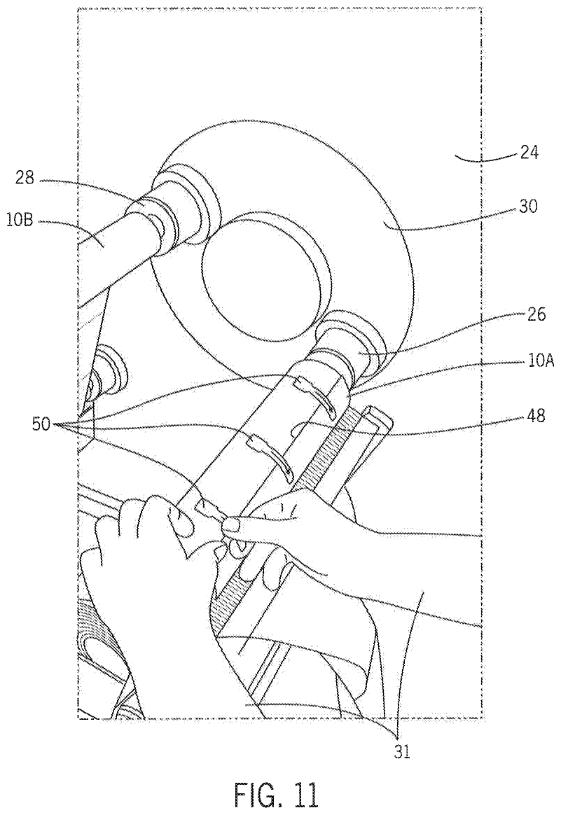

As shown in FIGS. 10 and 11, once the trailing end 46 of the first label web 12 of the next roll 10B is secured in the manner described above, the second spindle 28 is drivingly engaged by, and winding of the next roll 10B begins. While the next roll 10B is being wound, the operator 31 temporarily secures a leading end 48 of the length of first label web wound into the first roll 10A to the outer periphery of the first roll 10A with a series of removable adhesive tabs 50 to complete fabrication of the first roll 10A. The adhesive tabs 50 are coated with an adhesive that is only moderately sticky, so that the labels 18 at the leading edge 48 of the first roll 10A will not be damaged when the tabs 50 are removed during mounting of the first roll 10A in a printer.

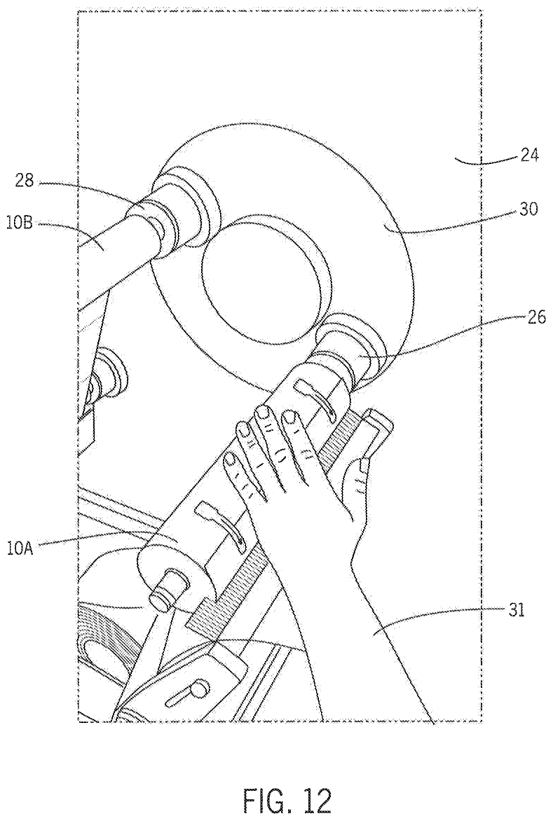

As illustrated in FIG. 12, the operator 31 can now remove the completed first roll 10A from the first spindle 26, so that the process described above with reference to FIGS. 2-12 can be repeated to produce additional rolls 10 of the first label web 12.

In a preferred embodiment of the invention, the double-sided releasable adhesive labels 32 are configured to form a removable adhesive bond between the core 14 and the underside 41 of the substrate 16 in such a manner that the trailing end 48 of the first label web 12 is secured to its core 14 during winding of the roll 10, but can pull free from the core 14 for printing of the last label 18 on the first label web 12.

From the forgoing description of exemplary embodiments, those having skill in the art will readily recognize that the present invention includes a number of aspects that provide significant improvement over prior roll configurations, and methods for making and using roles of label webs carrying adhesive-backed labels.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A roll of label web comprising a length of first label web having a plurality of longitudinally spaced adhesive-backed labels removably attached to a substrate wound around a tubular core in such a manner that a first and last label of the first label web are fully intact and usable.

2. The roll of claim 1, wherein the labels are disposed in a longitudinally spaced manner from one another along the first label web, and the leading and trailing ends of the first label web are cut between successive labels such that the first and last labels of the first label web are complete.

3. The roll of claim 1, wherein the trailing end of the first label web is attached to the core prior to winding using one or more double-sided releasable adhesive labels to form a removable adhesive bond between the core and an underside of the substrate in such a manner that the trailing end of the first label web is secured to the core during winding of the roll and can pull free from the core for printing of the last label on the first label web.

4. The roll of claim 3, wherein the double-sided releasable adhesive labels are part of an array of such labels configured to be released as a group from a second label web having longitudinally spaced arrays of the double-sided releasable adhesive labels releasably affixed to a substrate web of the second label web.

5. The roll of claim 4, wherein the double-sided releasable adhesive labels are covered by a peelable protective covering web in a manner that allows each longitudinally spaced array of the second label web to be individually selectively successively uncovered and removed as a group while the peelable protective covering web remains in place over successive label arrays of the second label web.

6. The roll of claim 1, wherein the leading end of the first label web is temporarily affixed to the completed roll with one or more removable adhesive tabs that are removable without damaging the first label of the label web.

7. A method for producing a roll of label web comprising winding a length of first label web having a plurality of longitudinally spaced adhesive-backed labels removably attached to a substrate wound around a tubular core in such a manner that a first and last label of the first label web are fully intact and usable.

8. The method of claim 7, wherein the labels are disposed in a longitudinally spaced manner from one another along the first label web, and further comprising cutting the leading and trailing ends of the first label web between successive labels such that the first and last labels of the first label web are complete.

9. The method of claim 7, further comprising attaching the trailing end of the first label web to the core prior to winding using one or more double-sided releasable adhesive labels to form a removable adhesive bond between the core and an underside of the substrate of the first label web in such a manner that the trailing end of the first label web is secured to the core during winding of the roll and can pull free from the core for printing of the last label on the first label web.

10. The method of claim 9, wherein the double-sided releasable adhesive labels are part of an array of such labels released as a group from a second label web having longitudinally spaced arrays of the double-sided releasable adhesive labels releasably affixed and to a substrate web of the second label web covered by a peelable protective covering web in a manner that allows each longitudinally spaced array of the second label web to be individually selectively successively uncovered and removed as a group while the peelable protective covering web remains in place over the successive label array of the second label web.

11. The method of claim 10, further comprising peeling the protective web away from one array of the double-sided releasable adhesive labels and applying the double-sided releasable adhesive labels of that one array to an outer surface of core prior to bringing the core into contact with a lower surface of the first label web beneath and opposite the last label of the first label web.

12. The method of claim 7, further comprising temporarily affixing the leading end of the first label web to the roll with one or more removable adhesive tabs that are removable without damaging the first label of the first label web.

13. A method for producing a roll of label web comprising;
providing a core;
applying a double-sided releasable adhesive label to an outer surface of the core;
bringing the core into contact with a lower surface of a label web beneath and opposite a last label of the label web;
winding a length of the label web having a plurality of longitudinally spaced adhesive-backed labels removably attached to a substrate around the core in such a manner that a first and last label of the first label web are fully intact and usable; and
cutting the leading and trailing ends of the first label web between successive labels such that the first and last labels of the first label web are complete.

14. The method of claim 13, further comprising temporarily affixing the leading end of the first label web to the roll with a removable adhesive tab that is removable without damaging the first label of the first label web.

15. The method of claim 13, wherein the labels are disposed in a longitudinally spaced manner from one another along the first label web.

16. The method of claim 13, further comprising:
providing a second core;
applying a double-sided releasable adhesive label to an outer surface of the second core;
bringing the second core into contact with a lower surface of the trailing end of the label web; and
attaching the trailing end of the first label web to the core prior to winding using the double-sided releasable adhesive label to form a removable adhesive bond between the core and an underside of the substrate of the first label web in such a manner that the trailing end of the first label web is secured to the core during winding of the roll and can pull free from the core for printing of the last label on the first label web.
